(19) United States
(12) Patent Application Publication
(10) Pub. No.: US 2025/0379007 A1
(43) Pub. Date: Dec. 11, 2025

(54) KEY STRUCTURE AND INPUT DEVICE

(71) Applicant: Lite-On Technology Corporation, Taipei (TW)

(72) Inventors: Cheng-Kun Liao, Taipei (TW); Chung-Hsien Yang, Taipei (TW); Ming-Fu Yen, Taipei (TW)

(73) Assignee: Lite-On Technology Corporation, Taipei (TW)

(21) Appl. No.: 19/227,530

(22) Filed: Jun. 4, 2025

Related U.S. Application Data
(60) Provisional application No. 63/657,096, filed on Jun. 6, 2024.

(30) Foreign Application Priority Data
Apr. 24, 2025 (CN) 202520793877.4

(51) Int. Cl. H01H 13/02; H01H 13/14; H01H 13/20

(52) U.S. Cl. CPC H01H 13/023; H01H 13/14; H01H 13/20

(57) ABSTRACT

A key structure, including a keycap, a bottom plate assembly, a light source, and a scissor assembly, is provided in the disclosure. The keycap has a light-transmitting region. The bottom plate assembly is located below the keycap. The light source is disposed on the bottom plate assembly. The scissor assembly is disposed between the keycap and the bottom plate assembly and is adapted to move in a first direction. The scissor assembly includes a first scissor and a second scissor pivotally connected to each other. Each of the first scissor and the second scissor is formed with an opening on a same side. The opening corresponds to the light source and the light-transmitting region in the first direction. Such layout facilitates a reduction in the size of the key structure and is advantageous for product miniaturization.

### CROSS-REFERENCE TO RELATED APPLICATION

This application claims the priority benefit of provisional application No. 63/657,096, filed on Jun. 6, 2024, and China application serial no. 202520793877.4, filed on Apr. 24, 2025. The entirety of each of the above-mentioned patent applications is hereby incorporated by reference herein and made a part of this specification.

### BACKGROUND

### Technical Field

The disclosure relates to a key structure, and in particular to a key structure applied on an input device.

### Description of Related Art

In electronic products such as the keyboard of a laptop computer, some keys may be provided with illumination to exhibit the characters on the keycap or serve as status indicators. Such design often requires the light source to be positioned outside the key body or at the corner of the keycap to avoid the light source interfered by the structure of the key body. This imposes significant limitations on layout flexibility and thus hinders the miniaturization of keys.

### SUMMARY

The disclosure is directed to a key structure whose layout facilitates product miniaturization.

A key structure of the disclosure includes a keycap, a bottom plate assembly, a light source, and a scissor assembly. The keycap has a light-transmitting region. The bottom plate assembly is located below the keycap. The light source is disposed on the bottom plate assembly. The scissor assembly is disposed between the keycap and the bottom plate assembly and is adapted to move in a first direction. The scissor assembly includes a first scissor and a second scissor pivotally connected to each other. The first scissor and the second scissor are each formed with an opening on a same side. The opening of the first scissor and the opening of the second scissor correspond to the light source and the light-transmitting region in the first direction.

In an embodiment of the disclosure, each of the first scissor and the second scissor includes a platform and a connecting portion, and the platform is connected between two scissor end portions through the connecting portion. The opening is formed on the platform.

In an embodiment of the disclosure, the horizontal position of the platform is higher than the horizontal position of the connecting portion in the first direction.

In an embodiment of the disclosure, the platform of the first scissor has an accommodating region on one side in a second direction, at least a portion of the platform of the second scissor is located in the accommodating region, and the second direction is perpendicular to the first direction.

In an embodiment of the disclosure, the platform of the first scissor and the platform of the second scissor are at least partially overlapped in the first direction.

In an embodiment of the disclosure, at least one of the opening of the first scissor and the opening of the second scissor is recessed from one side of the platform in a second direction, and the second direction is perpendicular to the first direction.

In an embodiment of the disclosure, the opening of the first scissor and the opening of the second scissor are oriented in opposite directions.

In an embodiment of the disclosure, the opening of the first scissor and the opening of the second scissor are oriented in the same direction.

In an embodiment of the disclosure, the opening of one of the first scissor and the second scissor is a through hole, and the through hole penetrates the platform in the first direction.

In an embodiment of the disclosure, the key structure further includes a reinforcing portion, and the reinforcing portion is disposed adjacent to the opening and extends in the first direction.

In an embodiment of the disclosure, the platform of one of the first scissor and the second scissor includes a barrel portion, and the barrel portion extends in the first direction along the edge of the opening.

In an embodiment of the disclosure, a gap exists between the platform and the light source.

In an embodiment of the disclosure, a gap exists between the lower surface of the scissor assembly and the bottom plate assembly.

In an embodiment of the disclosure, the bottom plate assembly includes a thin-film circuit layer and a bottom plate body. The thin-film circuit layer is disposed on the bottom plate body, and the light source is disposed on the thin-film circuit layer.

In an embodiment of the disclosure, the bottom plate assembly includes a bottom plate body and a backlight module. The backlight module is disposed below the bottom plate body, and the light source is disposed on the backlight module.

An input device of the disclosure includes the key structure.

In summary, in the key structure of the disclosure, the scissor assembly is disposed between the keycap and the bottom plate assembly and is adapted to move in the first direction. The first scissor and the second scissor of the scissor assembly are each formed with an opening on the same side and the openings correspond to the light source disposed on the bottom plate assembly and the light-transmitting region of the keycap. By forming openings on the scissor assembly, the light emitted from the light source may pass through these openings unimpededly and illuminate out of the keycap through the light-transmitting region. Therefore, the light source may be disposed below the scissor assembly rather than at a distant location, thereby allowing a reduction in planar dimensions, which is conducive to device miniaturization.

To make the aforementioned features and advantages of the disclosure more comprehensible, the following specific embodiments are described in detail with reference to the accompanying drawings.

### BRIEF DESCRIPTION OF THE DRAWINGS

FIG. 1 is a schematic view of a key structure according to an embodiment of the disclosure.

FIG. 2 is an exploded schematic view of the key structure of FIG. 1.

FIG. 3 is a partial schematic view of the key structure of FIG. 1 from another angle of view.

FIG. 4 is a cross-sectional schematic view of the key structure of FIG. 1 taken along line A-A.

FIG. 5 is a schematic view of a scissor assembly according to another embodiment of the disclosure.

FIG. 6 is a cross-sectional schematic view of the scissor assembly of FIG. 5 arranged in a key structure.

FIG. 7 is a cross-sectional schematic view of a key structure according to another embodiment of the disclosure.

FIG. 8 is a schematic view of a scissor assembly according to another embodiment of the disclosure.

FIG. 9 is a cross-sectional schematic view of the scissor assembly of FIG. 8 arranged in a key structure.

FIG. 10 is a cross-sectional schematic view of a key structure according to another embodiment of the disclosure.

### DESCRIPTION OF THE EMBODIMENTS

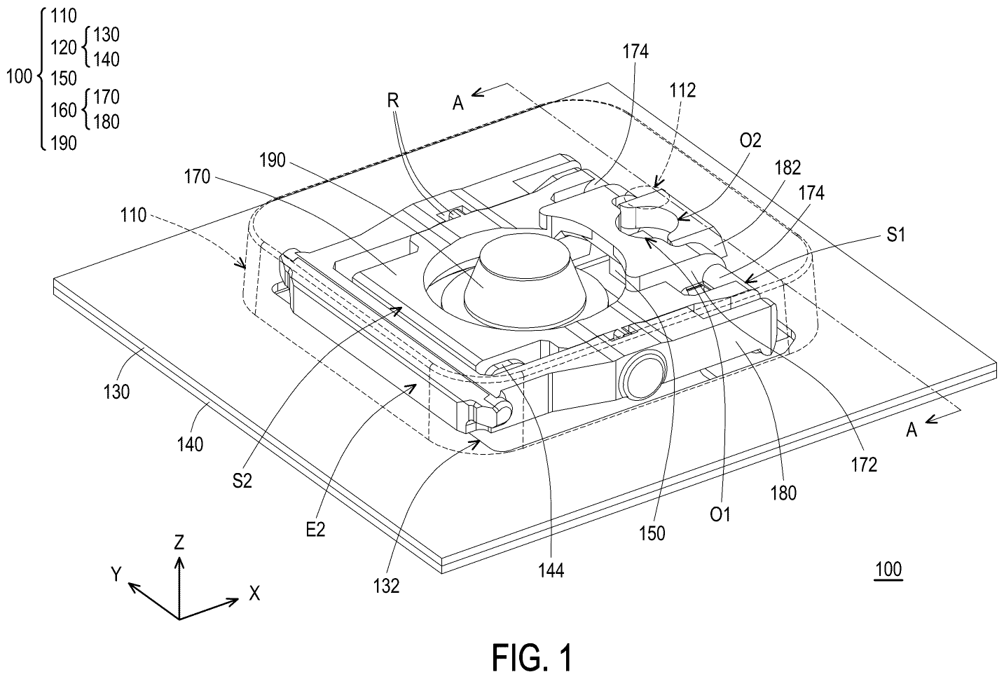

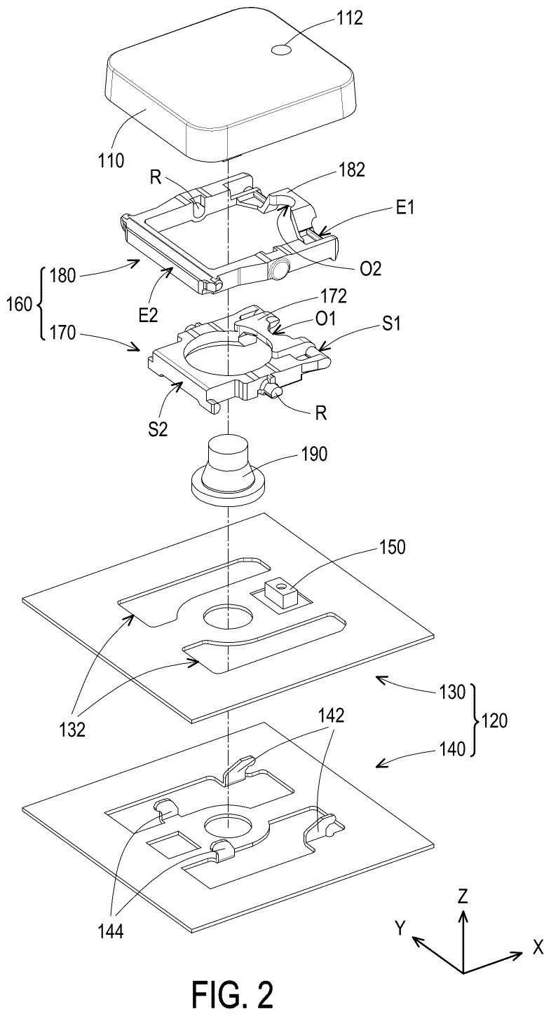

FIG. 1 is a schematic view of a key structure according to an embodiment of the disclosure FIG. 2 is an exploded schematic view of the key structure of FIG. 1. X, Y, Z are directions perpendicular to each other. To clearly present the structure covered under the keycap 110, the keycap 110 is drawn with dotted lines in FIG. 1. Referring to FIG. 1 and FIG. 2, the key structure 100 of the disclosure provides illumination and may be applied in an input device such as the keyboard of a laptop computer, but the type of the input device is not limited thereto.

The key structure 100 includes a keycap 110, a bottom plate assembly 120, a light source 150, a scissor assembly 160, and an elastic body 190. The keycap 110 has a light-transmitting region 112 to allow the light emitted from the light source 150 to pass through the light-transmitting region 112 and illuminate out of the keycap 110, so as to display the characters on the light-transmitting region 112 or indicate the status of the key (such as the active or inactive state of the Caps Lock function). The light-transmitting region 112, for example, is made of a light-transmitting material, or is an opening within the keycap 110 covered or filled with a light-transmitting layer.

The bottom plate assembly 120 is located below the keycap 110 and includes a thin-film circuit layer 130 and a bottom plate body 140. The thin-film circuit layer 130 is dispose on the bottom plate body 140, and the light source 150 is disposed on the thin-film circuit layer 130. The light source 150 is, for example, a light-emitting diode (LED), but the type of the light source 150 is not limited thereto. The elastic body 190 passes through the scissor assembly 160 and is disposed between the keycap 110 and the bottom plate assembly 120. The elastic body 190 may be deformed correspondingly when the keycap 110 is pressed, thereby storing elastic potential energy, and may lift the keycap 110 upward by releasing the elastic potential energy when the pressing force is removed. The elastic body 190 may also trigger a switch (not shown) on the thin-film circuit layer 130 when the keycap 110 is pressed.

The scissor assembly 160 in this embodiment is disposed between the keycap 110 and the bottom plate assembly 120 and is adapted to move in the Z direction (i.e., the first direction) to allow the keycap 110 to be pressed downward or lifted upward smoothly. The scissor assembly 160 includes a first scissor 170 and a second scissor 180 pivotally connected with each other. Specifically, in this embodiment, the first scissor 170 is located in the inner side of the second scissor 180, and each of the first scissor 170 and the second scissor 180 is provided with a pivot portion R at the middle section so that one may rotate relative to the other. That is, the first scissor 170 and the second scissor 180 are the inner scissor and the outer scissor, respectively, and the inner scissor and the outer scissor may rotate relative to each other via the pivot portions R. However, the arrangement of the first scissor 170 and the second scissor 180 is not limited thereto.

In this embodiment, the first side S1 of the first scissor 170 may be pivotally disposed on the keycap 110, and the second side S2 of the first scissor 170 opposite to the first side S1 in the X direction (i.e., the second direction) may be pivotally disposed on the bottom plate body 140 through the hook portion 144. Similarly, the first side E1 of the second scissor 180 may be pivotally disposed on the bottom plate body 140 through the hook portion 142, and the second side E2 of the second scissor 180 opposite to the first side E1 in the X direction may be pivotally disposed on the keycap 110. As a result, the keycap 110 may move upward and downward in the first direction relative to the bottom plate assembly 120 by the cooperation of the first scissor 170 and the second scissor 180.

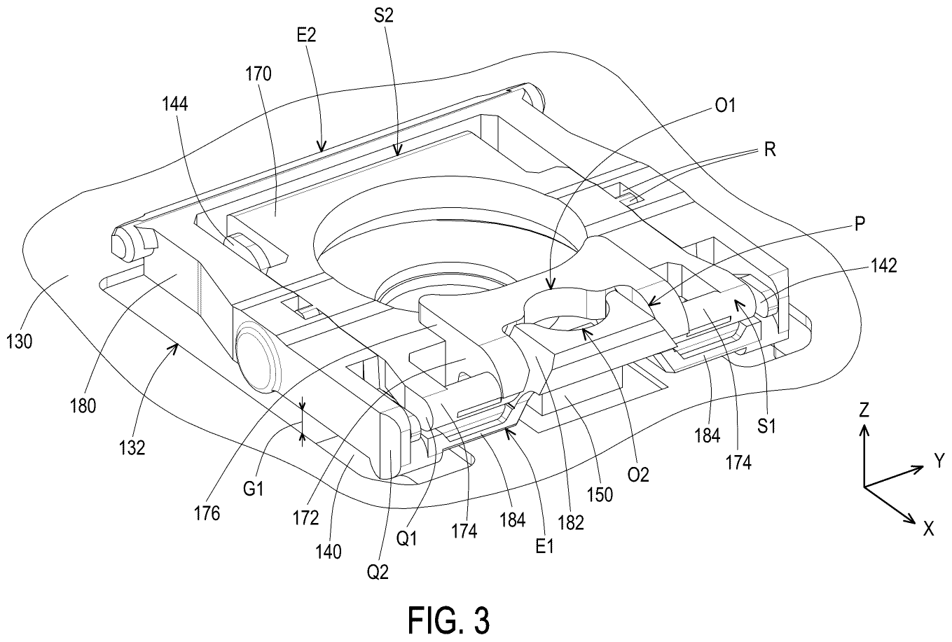

FIG. 3 is a partial schematic view of the key structure of FIG. 1 from another angle of view. To clearly present the structure of the scissor assembly 160, the elastic body 190 and the keycap 110 are hidden in FIG. 3. Referring to FIG. 3 and FIG. 2, the first side S1 of the first scissor 170 includes a platform 172 and a connecting portion 174. The platform 172 is connected between two scissor end portions Q1 through the connecting portion 174. Similarly, the first side E1 of the second scissor 180 includes a platform 182 and a connecting portion 184. The platform 182 is connected between two scissor end portions Q2 through the connecting portion 184.

An opening O1 is formed on the platform 172 of the first scissor 170, and an opening O2 is formed on the platform 182 of the second scissor 180. Specifically, in this embodiment, the opening O1 is recessed from the outer side of the platform 172 in the negative X direction, and the opening O2 is recessed from the inner side of the platform 182 in the positive X direction. In this way, the openings O1, O2 may be semi-openings oriented in opposite directions, so that when the first scissor 170 is assembled with the second scissor 180, the opening O1 and the opening O2 will face each other to jointly form a clearance space corresponding to the light source 150 and the light-transmitting region 112 (FIG. 1) in the Z direction. The shape and formation of the openings O1, O2 are not limited in the disclosure.

The aforementioned design forms a recessed structure on each of the first scissor 170 and the second scissor 180 of the scissor assembly 160, allowing the light emitted from the light source 150 to pass through the openings O1, O2 unimpededly and illuminate out of the keycap 110 through the light-transmitting region 112, without being blocked by the scissor assembly 160. Meanwhile, since the light source 150 may be disposed below the scissor assembly 160, rather than at a distant position from the key body to prevent the scissor assembly 160 from blocking the light source as in the prior art, the dimensions of the key structure 100 in the X-Y plane may be effectively reduced, thereby facilitating device miniaturization.

In addition, in this embodiment, the diameter of the openings O1, O2 is preferably larger than the diameter of the light-transmitting region 112 to ensure that the light emitted from the light source 150 may pass through the openings O1, O2 and illuminate the light-transmitting region 112. The ratio of the diameter of the light-transmitting region 112 to the diameter of the openings O1, O2 is preferably 1:1.5.

Additionally, a gap G1 exists between the lower surface of the scissor assembly 160 and the thin-film circuit layer 130 of the bottom plate assembly 120 in this embodiment. In other words, the scissor assembly 160 is raised in the Z direction relative to the thin-film circuit layer 130, so that the area required for the open slots 132 on the thin-film circuit layer 130 below the scissor assembly 160 may be reduced, increasing the space for arrangement of the light source 150 and other components, and thus effectively utilizing the layout space on the thin-film circuit layer 130.

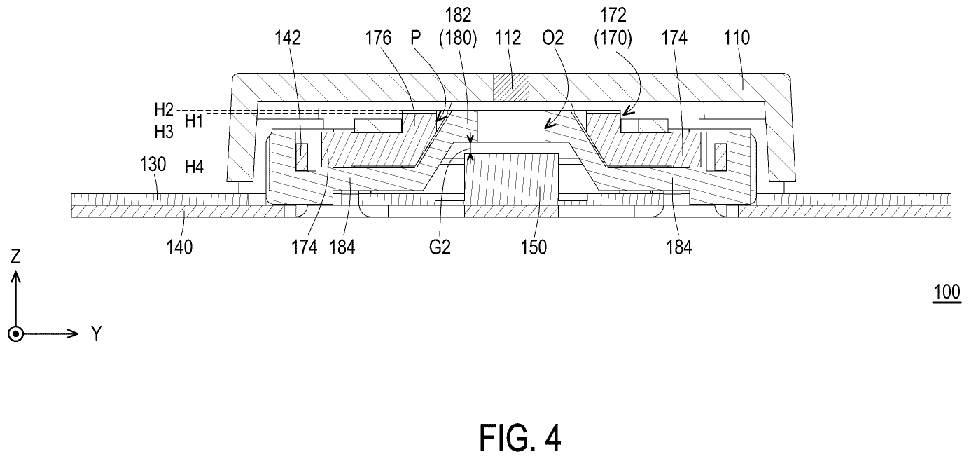

FIG. 4 is a cross-sectional schematic view of the key structure of FIG. 1 taken along line A-A. Referring to FIG. 3 and FIG. 4, the platform 172 of the first scissor 170 in this embodiment has an accommodating region P on one side in the X direction (i.e., the second direction), and at least a part of the platform 182 of the second scissor 180 is located in the accommodating region P. That is, the platform 172 of the first scissor 170 and the platform 182 of the second scissor 180 are arranged side by side in the X direction, reducing the dimension of the key structure 100 in the Z direction and thus facilitating a reduction in device thickness. The platforms 172, 182 in this embodiment may have the same height or have a height difference between them. The relative heights of the platforms 172 and 182 are not limited thereto.

Preferably, the horizontal positions H1, H2 of the platforms 172, 182 in the Z direction are higher than the horizontal positions H3, H4 of the connecting portions 174, 184, so as to form more clearance space in the Z direction. Preferably, a reinforcing portion 176 with a greater thickness in the Z direction than other spots of the platforms 172, 182 may be formed near the openings O1, O2 to enhance the structural strength of the platforms 172, 182.

In addition, a gap (depicted as the gap G2 between the platform 182 and the light source 150 in FIG. 4) is held between the platforms 172, 182 and the light source 150 in this embodiment. Such design ensures sufficient space below the first scissor 170 and the second scissor 180 to accommodate the light source 150 and prevents structural interference.

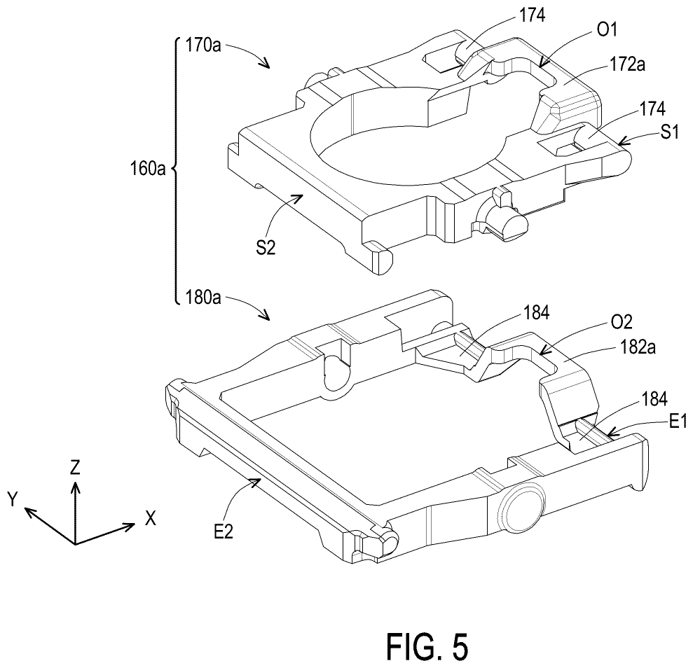

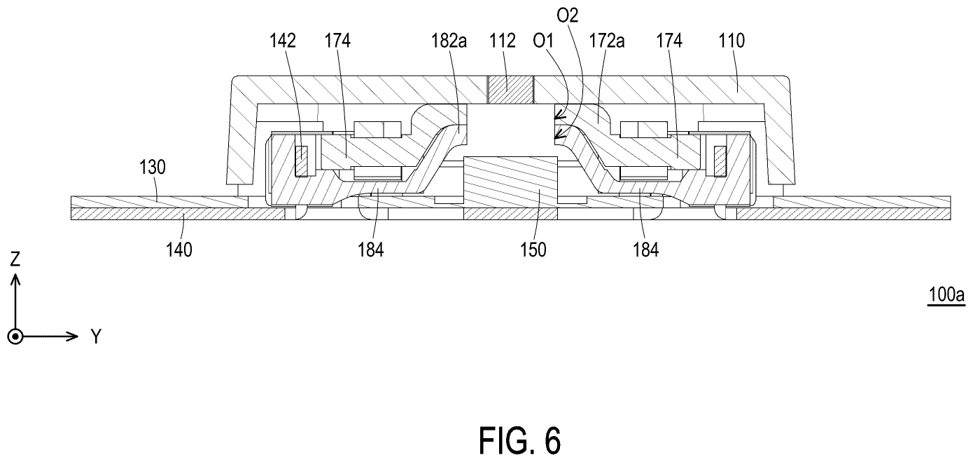

FIG. 5 is a schematic view of a scissor assembly according to another embodiment of the disclosure. FIG. 6 is a cross-sectional schematic view of the scissor assembly of FIG. 5 arranged in a key structure. A main difference between the embodiments shown in FIG. 5 and FIG. 1 is that the scissor assembly 160a is provided with a different structure and configuration, where the platform 172a of the first scissor 170a and the platform 182a of the second scissor 180a of the scissor assembly 160a may be at least partially overlapped in the first direction.

Referring to FIG. 5 and FIG. 6, in the key structure 100a of this embodiment, the platform 172a of the first scissor 170a is stacked on the platform 182a of the second scissor 180a in the Z direction and extends toward the keycap 110 (FIG. 6) to be more adjacent to the keycap 110. That is, the platform 172a of the first scissor 170a and the platform 182a of the second scissor 180a are not arranged side by side in the X direction. Meanwhile, the opening O1 of the first scissor 170a and the opening O2 of the second scissor 180a are wide semi-openings and oriented in the same direction, both facing the positive or negative X direction (FIG. 5). In this way, the scissor assembly 160a is provided with a clearance space, allowing the light emitted from the light source 150 (FIG. 6) to pass through the openings O1, O2 unimpededly and illuminate out of the keycap 110 through the light-transmitting region 112, without being blocked by the scissor assembly 160a.

The remaining components and configuration of the key structure 100a in this embodiment are identical or similar to the embodiment illustrated in FIG. 1 and will not be reiterated here.

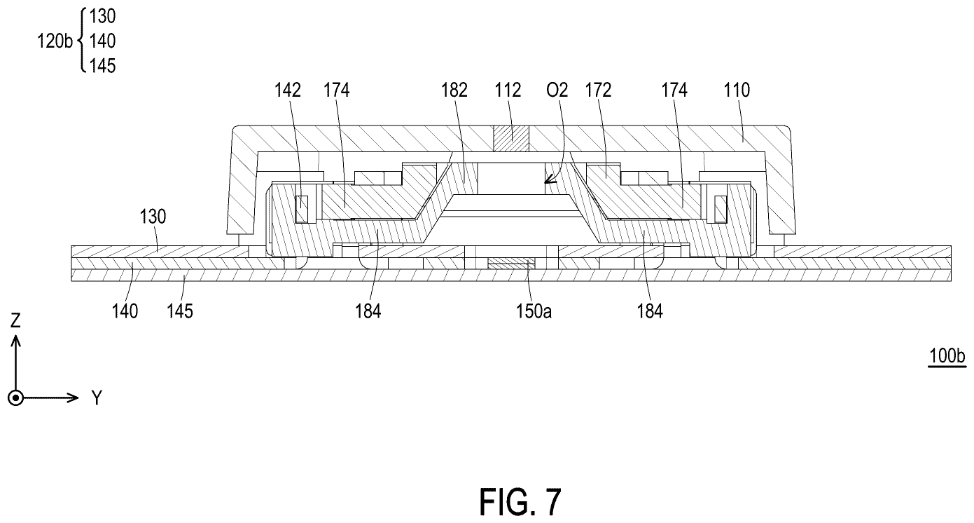

FIG. 7 is a cross-sectional schematic view of a key structure according to another embodiment of the disclosure. A main difference between the embodiments shown in FIG. 7 and FIG. 4 is that the bottom plate assembly 120b of the key structure 100b further includes a backlight module 145.

Specifically, the backlight module 145 in this embodiment provides a backlight function, for example, a light display with varying effects. The backlight module 145 is disposed below the bottom plate body 140. In this embodiment, the light source 150a may be disposed on the backlight module 145, and the light emitted from the light source 150a may pass through the opening (depicted as the opening O2) unimpededly and illuminate out of the keycap 110 through the light-transmitting region 112.

The remaining components and configuration of the key structure 100b in this embodiment are identical or similar to the embodiment illustrated in FIG. 4 and will not be reiterated here.

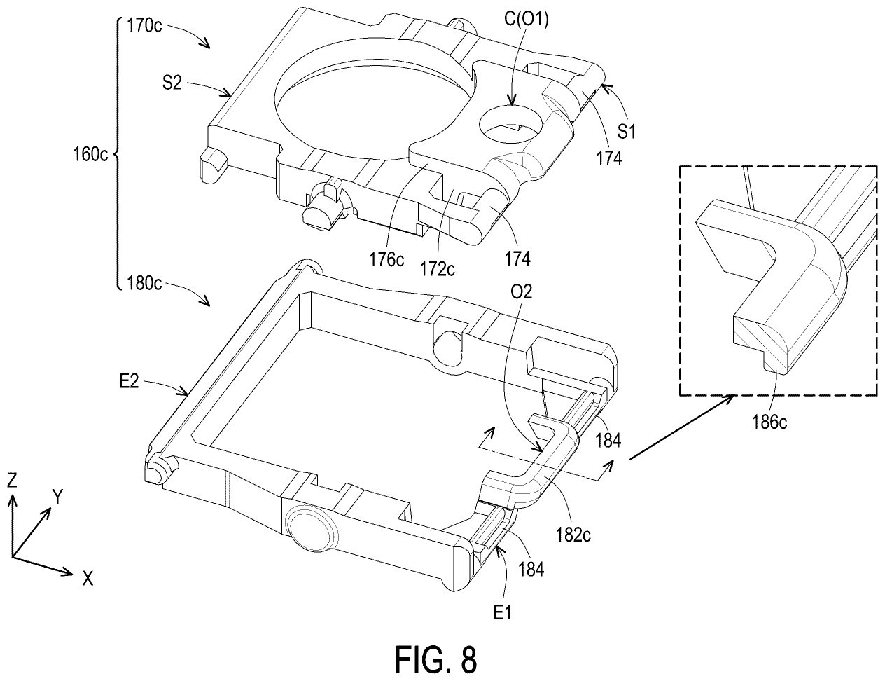

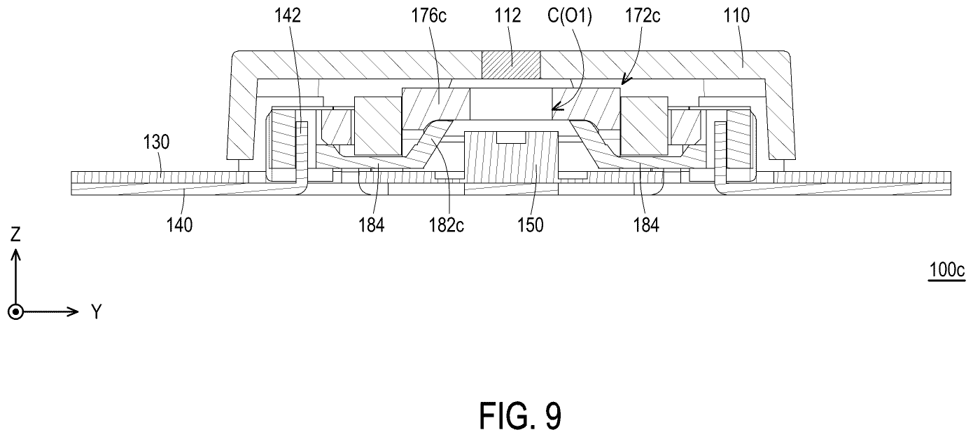

FIG. 8 is a schematic view of a scissor assembly according to another embodiment of the disclosure. FIG. 9 is a cross-sectional schematic view of the scissor assembly of FIG. 8 arranged in a key structure. A main difference between the embodiments shown in FIG. 8 and FIG. 1 is that the opening O1 of the first scissor 170c or the opening O2 of the second scissor 180c of the scissor assembly 160c may be a through hole.

Referring to FIG. 8 and FIG. 9, specifically, the opening O1 of the first scissor 170c is presented as a through hole C in this embodiment. The through hole C penetrates the platform 172c of the first scissor 170c in the Z direction and corresponds to the light-transmitting region 112 of the keycap 110 (FIG. 9) and the light source 150. To ensure appropriate structural strength for the platform 172c after the through hole C is disposed, a reinforcing portion 176c with increased thickness in the Z direction is preferably disposed around the through hole C. In this embodiment, the reinforcing portion 176c extends toward the keycap 110.

Moreover, the opening O2 of the second scissor 180c is, for example, a wide semi-opening. The opening O2 is recessed from the inner side of the platform 182c in the positive X direction. In this embodiment, a reinforcing portion 186c extending toward the light source 150 (FIG. 8) may be disposed on the outer side of the platform 182c. By further providing the reinforcing portion 186c, sufficient structural strength for the platform 182c may be ensured. In an embodiment not shown, the through hole C may be disposed on the second scissor 180c, the opening O2 may be disposed on the first scissor 170c, or both the first scissor 170c and the second scissor 180c may be provided with through holes C, but the arrangement and type of the through hole C and the opening O2 are not limited thereto.

The remaining components and configuration of the key structure 100c in this embodiment are identical or similar to the embodiment illustrated in FIG. 1 and will not be reiterated here.

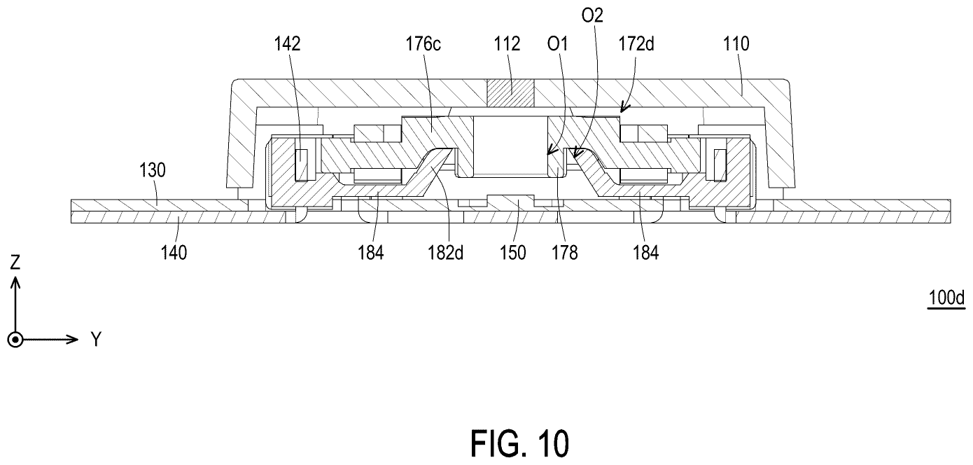

FIG. 10 is a cross-sectional schematic view of a key structure according to another embodiment of the disclosure. A main difference between the embodiment shown in FIG. 10 and the foregoing embodiments is that the platform 172d and/or the platform 182d also include a light-guiding structure extending in the Z direction.

Specifically, the light-guiding structure, for example, the barrel portion 178 may extend at the platform 172d of the first scissor from the periphery of the opening O1 toward the light source 150 (i.e., the negative Z direction), and/or at the platform 182d of the second scissor from the opening O2 toward the keycap 110 (i.e., the positive Z direction). Such design utilizes the barrel portion 178 to collect and guide the light emitted by the light source 150 toward the light-transmitting region 112 of the keycap 110, so as to avoid light divergence and effectively direct the light. In addition, the barrel portion 178 increases the thickness of the platform 172d and/or the platform 182d and therefore enhances the structural strength of the scissor assembly for its movement.

The remaining components and configuration of the key structure 100d in this embodiment are identical or similar to the foregoing embodiments and will not be reiterated here.

In summary, in the key structure of the disclosure, the scissor assembly is disposed between the keycap and the bottom plate assembly and is adapted to move in the first direction. The first scissor and the second scissor of the scissor assembly are each formed with an opening on the same side and the openings correspond to the light source disposed on the bottom plate assembly and the light-transmitting region of the keycap. By forming openings on the scissor assembly, the light emitted from the light source may pass through these openings unimpededly and illuminate out of the keycap through the light-transmitting region. Therefore, the light source may be disposed below the scissor assembly rather than at a distant location, thereby allowing a reduction in planar dimensions, which is conducive to device miniaturization.

Lastly, it should be noted that each of the above embodiments is used to describe the technical solutions of the invention instead of limiting them. Although the invention has been described in detail with reference to each embodiment above, those having ordinary skill in the art should understand that the technical solution recited in each embodiment above may still be modified, or some or all of the technical features thereof may be combined or equivalently replaced. These modifications, combinations, or replacements do not make the essence of the corresponding technical solutions depart from the scope of the technical solution of each embodiment of the invention.

What is claimed is:

1. A key structure, comprising:
a keycap, having a light-transmitting region;
a bottom plate assembly, located below the keycap;
a light source, disposed on the bottom plate assembly; and
a scissor assembly, disposed between the keycap and the bottom plate assembly and adapted to move in a first direction, wherein the scissor assembly comprises a first scissor and a second scissor pivotally connected to each other, the first scissor and the second scissor each formed with an opening on a same side, and the opening of the first scissor and the opening of the second scissor correspond to the light source and the light-transmitting region in the first direction.

2. The key structure according to claim 1, wherein each of the first scissor and the second scissor comprises a platform and a connecting portion, the platform is connected between two scissor end portions through the connecting portion, and the opening is formed on the platform.

3. The key structure according to claim 2, wherein a horizontal position of the platform is higher than a horizontal position of the connecting portion in the first direction.

4. The key structure according to claim 2, wherein the platform of the first scissor has an accommodating region on one side in a second direction, at least a portion of the platform of the second scissor is located in the accommodating region, and the second direction is perpendicular to the first direction.

5. The key structure according to claim 2, wherein the platform of the first scissor and the platform of the second scissor are at least partially overlapped in the first direction.

6. The key structure according to claim 2, wherein at least one of the opening of the first scissor and the opening of the second scissor is recessed from one side of the platform in a second direction, and the second direction is perpendicular to the first direction.

7. The key structure according to claim 2, wherein the opening of the first scissor and the opening of the second scissor are oriented in opposite directions.

8. The key structure according to claim 2, wherein the opening of the first scissor and the opening of the second scissor are oriented in a same direction.

9. The key structure according to claim 2, wherein the opening of one of the first scissor and the second scissor is a through hole, and the through hole penetrates the platform in the first direction.

10. The key structure according to claim 2, further comprising a reinforcing portion, wherein the reinforcing portion is disposed adjacent to the opening and extends in the first direction.

11. The key structure according to claim 2, wherein the platform of one of the first scissor and the second scissor comprises a barrel portion, and the barrel portion extends in the first direction along an edge of the opening.

12. The key structure according to claim 2, wherein a gap exists between the platform and the light source.

13. The key structure according to claim 1, wherein a gap exists between a lower surface of the scissor assembly and the bottom plate assembly.

14. The key structure according to claim 1, wherein the bottom plate assembly comprises a thin-film circuit layer and a bottom plate body, the thin-film circuit layer is disposed on the bottom plate body, and the light source is disposed on the thin-film circuit layer.

15. The key structure according to claim 1, wherein the bottom plate assembly comprises a bottom plate body and a backlight module, the backlight module is disposed below the bottom plate body, and the light source is disposed on the backlight module.

16. An input device, comprising the key structure according to claim 1.
